(19) United States
(12) Patent Application Publication
(10) Pub. No.: US 2007/0234306 A1
(43) Pub. Date: Oct. 4, 2007

(54) Tracing performance of machine-readable instructions

(76) Inventors: Uwe D. Klinger, Bad Schoenborn (DE); Brian Craig McKellar, Heidelberg (DE)

Correspondence Address: MINTZ, LEVIN, COHN, FERRIS, GLOVSKY & POPEO, P.C., 9255 TOWNE CENTER DRIVE, SUITE 600, SAN DIEGO, CA, 92121, US

(21) Appl. No.: 11/396,302

(22) Filed: Mar. 31, 2006

(51) Int. Cl. G06F 9/44

(52) U.S. Cl. 717/128

(57) ABSTRACT

Systems and techniques for tracing of the performance of machine-readable instructions are described. In one aspect, a machine-implemented method includes collecting interaction information regarding an interaction with a human user at a client data processing system in a system landscape, transmitting the collected interaction information to a tracing service, collecting internal information regarding a provision of services by a server data processing system in the system landscape, the provision of services being associated with the interaction with the human user at the client data processing system, transmitting the collected internal information to the tracing service, at the tracing service, conveying the collected interaction information and the collected internal information to at least one of a supporter and a developer in conjunction with a first notification that a performance of machine-readable instructions at system landscape is not meeting expectations.

### BACKGROUND

This disclosure relates to tracing of the performance of machine-readable instructions.

Debugging is the process of detecting, locating, and/or correcting errors in a set of machine-readable instructions. The errors can be, e.g., logical or syntactical. Debugging can include performing, or attempting to perform, data processing activities in accordance with the logic of the machine-readable instructions to determine if the performance conforms with expectations.

Such a performance of data processing activities can be traced. A trace is a record that characterizes a performance of data processing activities. Among the information that can be provided in a trace record are the names of subroutines that are performed and the values of variables at certain points during the data processing activities. By examining a trace record, a developer or other user can detect, locate, and/or correct errors in the instructions.

### SUMMARY

Systems and techniques for tracing of the performance of machine-readable instructions are described. In one aspect, a system includes a first tracing collector to collect interaction information regarding an interaction with a human user at a first data processing system in a system landscape during a performance of a set of machine-readable instructions, a second tracing collector to collect internal information regarding a provision of services by a second data processing system in the system landscape to the first data processing system during the performance of the set of machine-readable instructions, and a tracing application to receive the interaction information from the first tracing collector and the internal information from the second tracing collector and to assemble the interaction information and the internal information into a trace file regarding the performance. The provision of services is associated with the interaction with the human user.

This and other aspects can include one or more of the following features. The first tracing collector can include a portion of an application that interacts with the human user. The information regarding the interaction with the human user can include a screen shot during the interaction. The second tracing collector can include a supplemental application that collects data regarding a second application for the provision of the services. The internal information can include at least one of a name of a subroutine and a value of a data variable.

The trace file can include step-invariant trace data that does not change during the performance and step-variant trace data that changes during the performance. The system can include a third tracing collector to collect a user comment regarding the performance of the set of instructions. The tracing application can receive the user comment from the third tracing collector and assembles the user comment into the trace file. The tracing application can assemble the interaction information and the internal information into a data structure that includes step-delimited collections of time-variant information. The data structure can include a trace session file that is delimited as to a particular set or subset of machine-readable instructions whose performance is traced.

In another aspect, an article includes one or more machine-readable media storing instructions operable to cause one or more machines to perform operations. The operations can include receiving client tracing information that is relevant to a performance of a set of machine-readable instructions at a client data processing system in a data processing system landscape, receiving server tracing information that is relevant to the same performance of the same set of machine-readable instructions at a server data processing system in the data processing system landscape, and assembling the client tracing information and the server tracing information to generate a trace file regarding the performance of the set of machine-readable instructions.

This or other aspects can include one or more of the following features. The operations can also include receiving a user comment on the performance of the set of machine-readable instructions, and assembling the user comment into the trace file.

An identity of a human user can be received and requests from one or more applications can be responded to in order to indicate that operations performed for the human user are to be traced. The human user can be notified about the tracing of operations to be performed for the human user. The server tracing information can include internal information regarding a provision of services by the server data processing system to the client data processing system. The client tracing information can include interaction information regarding an interaction with a human user at the client data processing system.

The server tracing information can include step-invariant trace data that does not change during the performance of the set of machine-readable instructions and step-variant trace data that changes during the performance of the set of machine-readable instructions. The client tracing information and the server tracing information can be assembled to generate the trace file by adding the client tracing information and the server tracing information to a subdivision of a structured trace file. The subdivision can be associated with a step in the performance of the set of machine-readable instructions. The client tracing information and the server tracing information can be assembled by comparing the client tracing information with the server tracing information to identify instructions to which the client tracing information and the server tracing information are relevant.

In another aspect, a machine-implemented method includes collecting interaction information regarding an interaction with a human user at a client data processing system in a system landscape, transmitting the collected interaction information to a tracing service, collecting internal information regarding a provision of services by a server data processing system in the system landscape, the provision of services being associated with the interaction with the human user at the client data processing system, transmitting the collected internal information to the tracing service, at the tracing service, conveying the collected interaction information and the collected internal information to at least one of a supporter and a developer in conjunction with a first notification that a performance of machine-readable instructions at system landscape is not meeting expectations.

This or other aspects can include one or more of the following features. A user comment regarding the performance of the set of instructions at a client data processing system in a system landscape can be collected. The user comment can be transmitted to the tracing service. At the tracing service, the user comment can be conveyed with the first notification. At least some of the collected interaction information and the collected internal information can be outputted to at least one of the supporter and the developer.

The details of one or more implementations are set forth in the accompanying drawings and the description below. Other features and advantages will be apparent from the description and drawings, and from the claims.

### DESCRIPTION OF DRAWINGS

FIG. 1 is a schematic representation of a distributed data processing system landscape.

FIG. 2 is a schematic representation of another implementation of a system landscape.

FIG. 3 shows an implementation of a system for tracing the performance of machine-readable instructions in the system landscape of FIG. 1.

FIG. 4 shows an implementation of a system for tracing the performance of machine-readable instructions in the system landscape of FIG. 2.

FIG. 5 is a flowchart of a process for tracing the performance of machine-readable instructions in a system landscape.

FIG. 6 schematically illustrates one implementation of the receipt and the assembly of tracing information.

FIG. 7 is a flowchart of a process for tracing the performance of machine-readable instructions in a system landscape.

FIG. 8 is a flowchart of a process for tracing the performance of machine-readable instructions in a system landscape.

FIG. 9 is a schematic representation of an arrangement where tracing the performance of machine-readable instructions in a system landscape can be beneficial to debugging.

FIG. 10 is a flowchart of a process for tracing the performance of machine-readable instructions in a system landscape to debug the instructions.

Like reference symbols in the various drawings indicate like elements.

### DETAILED DESCRIPTION

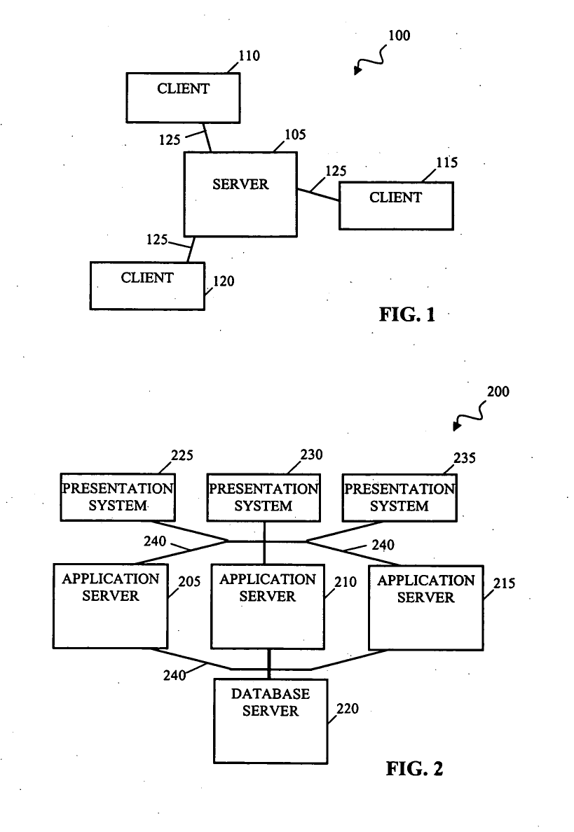

FIG. 1 is a schematic representation of a distributed data processing system landscape 100. A distributed data processing system landscape can include a collection of data processing devices, software, and/or systems (hereinafter “data processing systems”) that operate autonomously yet coordinate their operations across data communication links in a network. By operating autonomously, the data processing systems can operate in parallel, handling local workloads of data processing activities. The data communication links allow information regarding the activities, including the results of performance of the activities, to be exchanged between data processing systems. To these ends, many distributed data processing systems include distributed databases and system-wide rules for the exchange of data.

System landscape 100 thus is a collection of data processing systems that exchange information for the performance of one or more data processing activities in accordance with the logic of a set of machine readable instructions. System landscape 100 includes one or more servers 105 that are in communication with a collection of clients 110, 115, 120 over a collection of data links 125.

Server 105 is a data processing system that provides services to clients 110, 115, 120. The services can include, e.g., the provision of data, the provision of instructions for processing data, and/or the results of data processing activities. The services can be provided in response to requests from clients 110, 115, 120.

The services can be provided by server 105 in accordance with the logic of one or more applications. An application is a program or group of programs that perform one or more sets of data processing activities. An application can perform data processing activities directly for a user or for another application. Examples of applications include word processors, database programs, Web browsers, development tools, drawing, paint, image editing programs, and communication programs. In the context of enterprise software that is operable to integrate and manage the operations of a company or other enterprise, applications can be allocated to managing product lifecycles, managing customer relationships, managing supply chains, managing master data, managing financial activities, and the like. Applications use the services of the computer's operating system and other supporting applications. Applications can exchange information using predefined protocols.

Clients 110, 115, 120 are data processing systems that receive services from server 105. Clients 110, 115, 120 can be responsible for other data processing activities, such as managing interaction with human users at their respective locations. Clients 110, 115, 120 can generate requests for such services and convey the requests to server 105 over one or more of data links 125.

Data links 125 can form a data communication network such as a LAN, a WAN, or the Internet. System landscape 100 can also include additional data links, including direct links between clients 110, 115, 120 and data links to systems and devices outside landscape 100, such as a communications gateway (not shown).

The roles of “server” and “client” can be played by the same individual data processing system in system landscape 100. For example, the data processing system denoted as server 105 may receive certain services from one of clients 110, 115, 120. Thus, a data processing system may be a “server” in the context of a first set of services but a “client” in the context of a second set of services.

FIG. 2 is a schematic representation of another implementation of a system landscape, namely, a system landscape 200. System landscape 200 is a three tiered hierarchy of data processing systems and includes application servers 205, 210, 215, one or more database servers 220, and presentation systems 225, 230, 235. Application servers 205, 210, 215 and database server 220 are in data communication with each other and with presentation systems 225, 230, 235 over a collection of data links 240.

Application servers 205, 210, 215 are data processing systems that provide services to presentation systems 225, 230, 235 and/or database server 210. Each application server 205, 210, 215 can provide services in accordance with the logic of one or more applications. However, individual application servers can also provide services in accordance with the logic of multiple applications, and services in accordance with the logic of a single application can be provided by multiple application servers.

Database server 220 is a data processing system that provides storage, organization, retrieval, and presentation of instructions and data services to application servers 205, 210, 215 and/or presentation systems 225, 230, 235.

Presentation systems 225, 230, 235 are data processing systems that receive services from application servers 205, 210, 215 and database server 220. Presentation systems 225, 230, 235 can also manage interaction with human users at their respective locations, such as the display of information on a graphical user interface. Presentation systems 225, 230, 235 can generate requests for services and convey the requests to application servers 205, 210, 215 and database server 220 over one or more of data links 240.

In system landscapes such as landscapes 100, 200, one or more users may seek to debug the machine-readable instructions that form the basis of data processing activities. Such debugging can be performed by tracing the performance of machine-readable instructions in landscapes 100, 200.

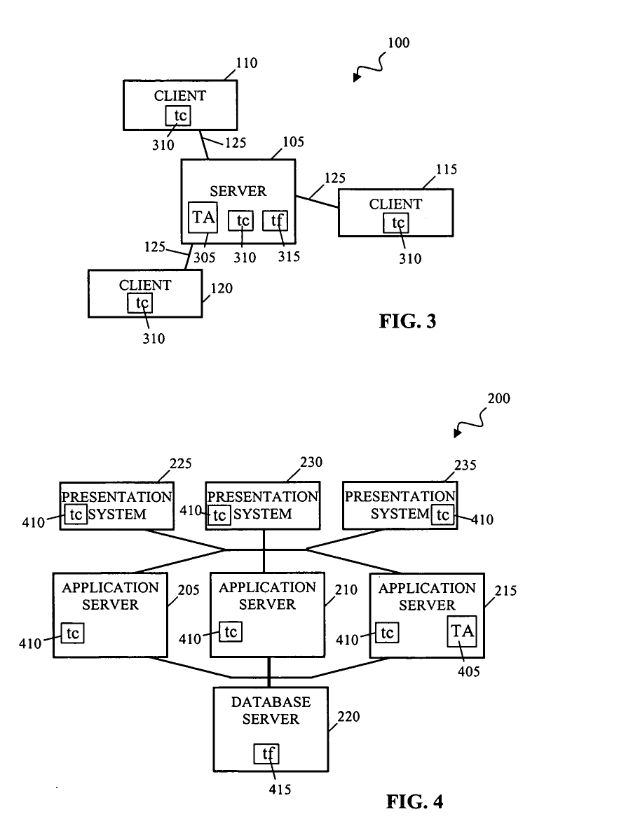

FIG. 3 shows an implementation of a system for tracing the performance of machine-readable instructions in landscape 100. In particular, a system for tracing the performance of machine-readable instructions includes a tracing application 305, a collection of two or more tracing collectors 310, and a trace file 315.

Tracing application 305 is a program or group of programs that provide services relating to tracing the performance of data processing activities in landscape 100. Tracing application 305 can receive information over data links 125 from other data processing systems in landscape 100 to trace the performance of applications at those (or other) data processing systems. For example, tracing application 305 can receive information by way of tracing collectors 310. Tracing application 305 can be implemented as a network accessible service that provides tracing services.

Tracing collectors 310 can be a portion of one or more applications in landscape 100 that collect trace data and submit it to tracing application 305. Tracing collectors 310 can also be supplemental applications that collect and submit trace data regarding other applications. Tracing collectors 310 exist both at server 105 and clients 110, 115, 120. Tracing collectors 310 can also exist at any additional tiers in a data processing landscape and at one or more application layers. Tracing collectors 310 can provide trace data to tracing application 305 in a proprietary format or in an open format. For example, tracing collectors 310 can provide trace data to tracing application 305 in a text or XML file. The trace data submitted to tracing application 305 can be tagged with information identifying the context in which trace data was generated. Such context information can include, e.g., a timestamp, the identity of a set of machine-readable instructions, and/or inputs to and/or outputs from the machine-readable instructions.

Trace file 315 is a collection of trace data that is assembled by tracing application 305 from the trace data collected and submitted by tracing collectors 310. Trace file 315 can be assembled using the context information that tags trace data. For example, trace file 315 can be assembled by placing trace data in chronological and/or logical order.

Trace file 315 can be associated with a single trace session. A trace session is a delimited performance of particular machine-readable instructions. A trace session can be delimited, e.g., in time, as to the user who requests the performances, as to the receipt of start and/or stop triggers, and/or as to a particular set or subset of machine-readable instructions whose performance is traced.

Trace file 315 can include step-invariant trace data and step-variant trace data. Step-invariant trace data is data that does not change during the course of a trace session. Example step-invariant data includes data regarding the data processing system landscape, such as, e.g., the version(s) of machine-readable instructions in the landscape, any patch(es) on the machine-readable instructions, setting(s) for machine-readable instructions, and any customization of machine-readable instructions (e.g., at either or both of the client and the server). Step-variant trace data is data that does change during the course of a trace session. Step-variant trace data is thus generally associated with the performance of a particular set of machine-readable instructions.

Trace file 315 can be a structured data collection, such as a list, a table, a record, a data object, or the like. The trace data in trace file 315 can be subdivided in accordance with the structure of the data collection. For example, trace data in trace file 315 can be divided and the resulting divisions stored in different portions of the data collection structure that are associated with particular interaction steps. Interaction steps are one or more associated inputs to and/or outputs from a traced application. The inputs and/or outputs can be between the traced application and a human user or between the traced application and another application:

Trace file 315 can be stored at server 105, as shown, or elsewhere in system landscape 100. Trace file 315 can be structured into a file, packed, compressed, or otherwise prepared for storage. Trace file 315 can also include metadata or executable instructions that are relevant to accessing trace data.

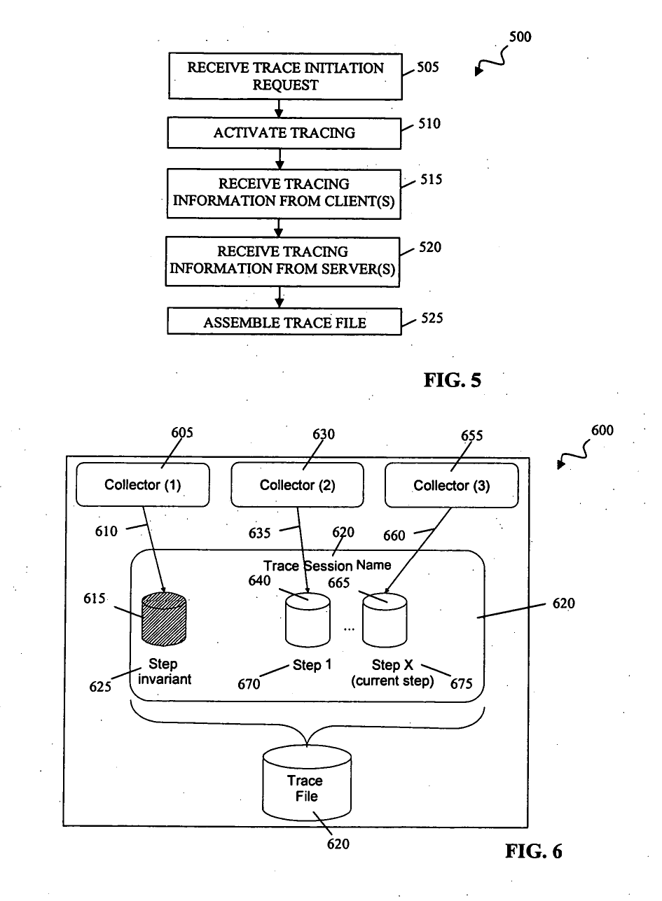

FIG. 4 shows an implementation of a system for tracing the performance of machine-readable instructions in landscape 200. In particular, a system for tracing the performance of machine-readable instructions includes a tracing application 405, a collection of two or more tracing collectors 410, and a trace file 415.

Tracing application 405 is a program or group of programs that provide services relating to tracing the performance of data processing activities in landscape 400. Tracing application 405 can receive information over data links 125 from tracing collectors 410 in landscape 100 to trace the performance of those or other applications.

Tracing collectors 410 can be a portion of one or more applications in landscape 200 that collect trace data and submit it to tracing application 405. Tracing collectors 310 can also be supplemental applications that collect and submit trace data regarding other applications. Tracing collectors 410 exist both at application servers 205, 210, 215 and presentation systems 225, 230, 235. Tracing collectors 410 can also exist at any additional tiers in a data processing landscape and at one or more application layers.

Trace file 415 is a collection of trace data that is assembled by tracing application 405 from the trace data collected and submitted by tracing collectors 410. Trace file 415 can be stored at database server 220, as shown, or elsewhere in system landscape 200.

FIG. 5 is a flowchart of a process 500 for tracing the performance of machine-readable instructions in a system landscape. Process 500 can be performed by a system for tracing, such as shown in FIGS. 3 and 4.

The system performing process 500 can receive a trace initiation request at 505. The request can be a user-initiated event, such as the selection of a key or a “trace activation” button at an I/O device. The trace initiation request can identify a particular set of instructions whose performance is to be traced. For example, the trace initiation request can identify a particular section of code and/or a specific functional set of data processing activities. Alternatively, the trace initiation request can include the identity of a specific user, and instructions subsequently accessed by that user are to be traced.

The system performing process 500 can activate tracing at 510. The activation of tracing can include informing remote trace collectors over one or more data links that tracing is to begin. The activation of tracing can also include informing remote trace collectors about which instructions whose performance is to be traced and/or the identity of a specific user whose accessed instructions are to be traced.

The system performing process 500 can receive tracing information from one or more clients in a system landscape at 515. The tracing information received from one or more clients can be associated with the performance of an identifiable sequence of machine-readable instructions. For example, the received tracing information can be tagged or otherwise labeled so that the instructions to which the tracing information is relevant can be determined. The received tracing information can also be tagged with information identifying the context in which tracing information was generated. Such context information can include, e.g., a timestamp, the identity of a set of machine-readable instructions, and/or inputs to and/or outputs from the machine-readable instructions.

The system performing process 500 can receive tracing information from one or more servers in a system landscape at 520. The tracing information from one or more servers can be associated with the performance of the same sequence of machine-readable instructions that is associated with the tracing information received from one or more clients at 515. In other words, tracing information from both client(s) and server(s) that is relevant to the same performance of the same sequence of machine-readable instructions can be obtained. This increases the amount of information provided to the system performing process 500 and can aid in any debugging of the performed instructions.

The tracing information received from one or more servers can also be tagged or otherwise labeled so that the instructions to which the tracing information is relevant can be determined. The tracing information received from one or more servers can also be tagged with information identifying the context in which tracing information was generated. Such context information can include, e.g., a timestamp, the identity of a set of machine-readable instructions, and/or inputs to and/or outputs from the machine-readable instructions. Using such labels, the tracing information received from one or more servers can be sorted, aligned, or otherwise compared with the tracing information received from one or more clients.

The system performing process 500 can assemble a trace file at 520. The assembled trace file can include some or all of the tracing information received from one or more clients and the tracing information received from one or more servers. The trace file can be assembled using context information found in labels on the tracing information. The trace file can be, e.g., a set of structured HTML pages with links to tracing information. The tracing information can be formatted for searching and filtering, e.g., using an XSLT transformation on XML tracing information.

FIG. 6 schematically illustrates one implementation of the receipt of tracing information from one or more clients and one or more servers and the assembly of the tracing information into trace file. In particular, a first trace collector 605 supplies time invariant tracing information 610 for storage in a subdivision 615 of a trace file 620. Trace file 620 can be labeled with a trace session name 625 and subdivision 615 can be labeled or otherwise denoted and including time invariant trace data at 625.

As the performance of machine-readable instructions proceeds, a second collector 630 supplies time variant tracing information 635 for storage in a subdivision 640 and a third collector 655 supplies time variant tracing information 560 for storage in a subdivision 665. Subdivision 640 can be labeled or otherwise denoted as including time variant trace data that is associated with a particular interaction step at 670 and subdivision 665 can be labeled or otherwise denoted as including time variant trace data that is associated with a particular interaction step at 675. The association of time variant trace data with a particular interaction step can be used to determine the instructions to which the tracing information is relevant and to sort, align, or otherwise compare tracing information received from collectors at one or more servers and clients. Note that tracing information relevant to the same step can be received from two or more collectors (not shown). The assembled trace file can reside at any location in a data processing system landscape.

FIG. 7 is a flowchart of a process 700 for tracing the performance of machine-readable instructions in a system landscape. Process 700 can be performed by a system for tracing, such as shown in FIGS. 3 and 4. Process 700 can be performed to assemble a collection of data associated with an interaction step. For example, process 700 can be performed to assemble subdivisions 640, 665 in a trace file 620 (FIG. 6). Process 700 can be performed in isolation or as part of a large collection of data processing activities. For example, process 700 can be performed at 515, 520 (FIG. 5).

The system performing process 700 can receive a record of interaction with the performance of a set of instructions at 705. The performance of a set of instructions can interact with a human or with one or more other applications. For example, the performance of instructions can interact with a human over one or more input and/or output devices, such as, e.g., a keyboard, a mouse, a touch- or display-screen or pad, a microphone, or the like. A record of interaction with a human can include, e.g., a record of keystrokes, mouse movement, speech, screenshots, and/or the like. The performance of instructions can interact with an application by exchanging data and/or instructions. A record of interaction with an application can include, e.g., a record of data input into the or output from set of instructions and the like. A record of interaction with an application can also include a tag or other information identifying the context in which the interaction occurred.

The system performing process 700 can also receive a record of internal technical information regarding the performance of the set of instructions at 710. Technical information is “internal” when it is not output to a human and/or another application. For example, the value of certain variables at different points during the data processing activities can be internal to the performance of a set of instructions and not output to a human or to another application. A record of internal technical information can also include a tag or other information identifying the context in which the technical information was generated.

The system performing process 700 can also receive a record of user comments regarding the performance of the set of instruction at 715. The user comments can be input by a human to annotate the performance of a set of instructions without actually interacting with the performance. For example, during the performance of a set of instructions, a user can comment on the performance and whether or not the performance meets the user's expectations. A record of user comments can also include a tag or other information identifying the context about which the user comments were made. The user comments can be input using any of a number of input devices, including a keyboard; a mouse, a microphone, a touchscreen, and/or the like. The record of user comments can thus be a record of keystrokes, mouse movement, speech, screenshots, and/or the like.

Note that the records of user comments, of internal technical information, and of interaction with the performance of a set of instructions can be received from one or more trace collectors at one or more clients and/or servers. For example, in the context of FIG. 4, a user's comments can be received from trace collector 410 at presentation system 235, internal technical information can be received from trace collector 410 at application server 210, and screen shots of a user's interaction with presentation system 225 can be received from trace collector 410 at presentation system 225.

Also note that the records of user comments, of internal technical information, and of interaction with the performance of a set of instructions can be tagged or otherwise labeled so that the instructions to which the tracing information is relevant, and the context of the performance of those instructions, can be determined. Moreover, using such labels, the records of user comments, of internal technical information, and of interaction with the performance of a set of instructions can be sorted, aligned, or otherwise compared. If appropriate, information drawn from the records of user comments, of internal technical information, and of interaction with the performance of a set of instructions can be stored in the same subdivision of a structured trace file.

FIG. 8 is a flowchart of a process 800 for tracing the performance of machine-readable instructions in a system landscape. Process 800 can be performed by a system for tracing, such as shown in FIGS. 3 and 4.

The system performing process 800 can receive a trace initiation request that specifies a user at 805. The request can specify a user in that one or more individuals is identified as relevant to a particular tracing session. The request can specify a user by name, by role, or by other identifying information. In some implementations, a trace initiation request that specifies a user can only be made by that user.

The system performing process 800 can flag tracing activation for the specified user at 810. The flag can be, e.g., an element in a shared memory that is associated with the specified user to indicate that tracing is activated for the specified user.

The system performing process 800 can notify the specified user about the tracing at 815. The notification can be, e.g., an icon or other element on a display or other output device that indicates to the specified user that tracing is activated.

The system performing process 800 can create a trace file instance at 820. The trace file instance is a particular trace file associated with a particular tracing session for the specified user. The trace file instance can be named or otherwise denoted as associated with a particular trace session.

The system performing process 800 can respond to requests from applications in a system landscape that regard the specified user with the tracing activation flag at 825. Such requests can be generated by one or more applications in a system landscape whenever services are provided for any user. The requests can identify whether or not tracing is activated for a data processing activities performed by those applications for a user.

The system performing process 800 can log the tracing activities in a security log file of one or more application servers at 830. The log can describe the identity of the specified user, the applications traced, the time and nature of the activation of tracing by the user, and other data related to the tracing such as the time of tracing and the like.

The system performing process 800 can receive tracing information from one or more trace collectors at 835. The trace collectors can be located at one or more servers and/or one or more clients in the system landscape. The tracing information can include records of user comments, records of internal technical information, and records of interaction with the performance of a set of instructions and the like. The tracing information can be pushed from the trace collectors to the system performing process 800 and/or the system performing process 800 can pull the tracing information from the trace collectors.

The system performing process 800 can assemble the received tracing information into the created trace file instance at 840. For example, the trace file instance can be assembled as schematically illustrated in FIG. 6.

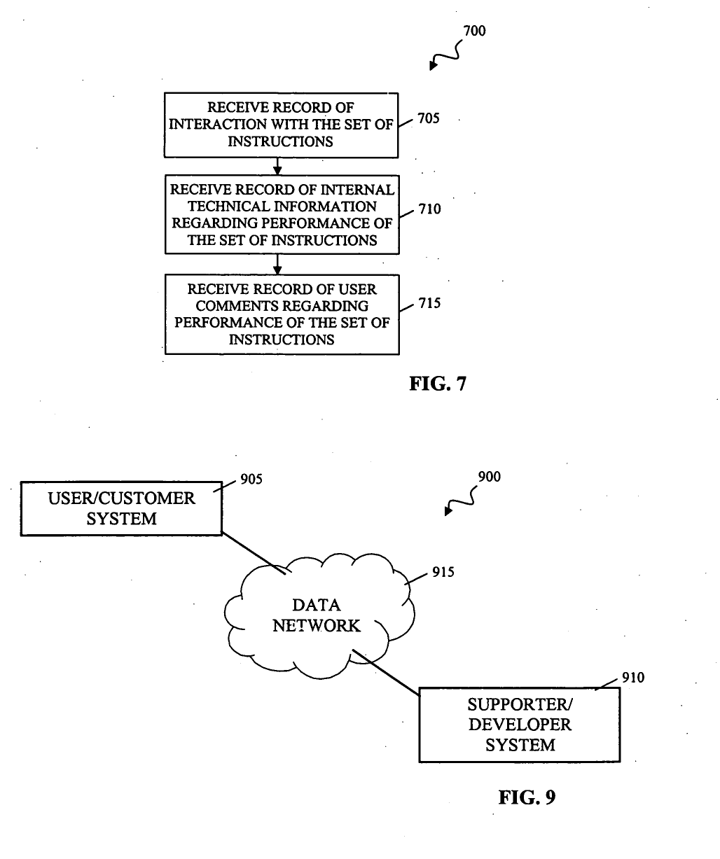

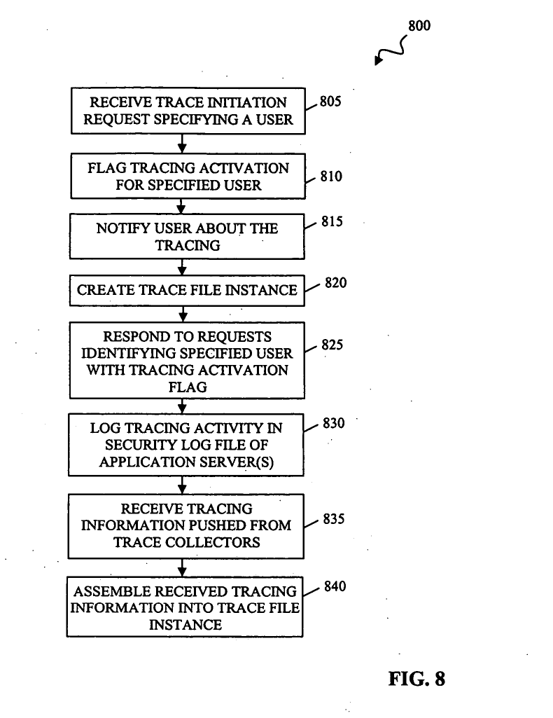

FIG. 9 is a schematic representation of an arrangement 900 where tracing the performance of machine-readable instructions in a system landscape can be beneficial to debugging of those machine-readable instructions.

Arrangement 900 includes a user/customer system 905 and a supporter/developer system 910 that exchange data over a data network 915. In this context, a user is an individual who performs operations on a set of machine readable instructions. A customer is an individual responsible for the operation of the set of machine readable instructions used by the user. The user and the customer can be employees of a company or other entity that has obtained rights to a set of machine readable instructions.

A supporter is an individual responsible for customer support of the operation of the set of machine readable instructions. A developer is an individual responsible for developing the set of machine readable instructions. The supporter and the developer can be employees of a software company that has transferred rights to the employer of the user and the customer.

Data network 915 can be public or private network over which information can be exchanged between user/customer system 905 and supporter/developer system 910. For example, data network 915 can be the Internet.

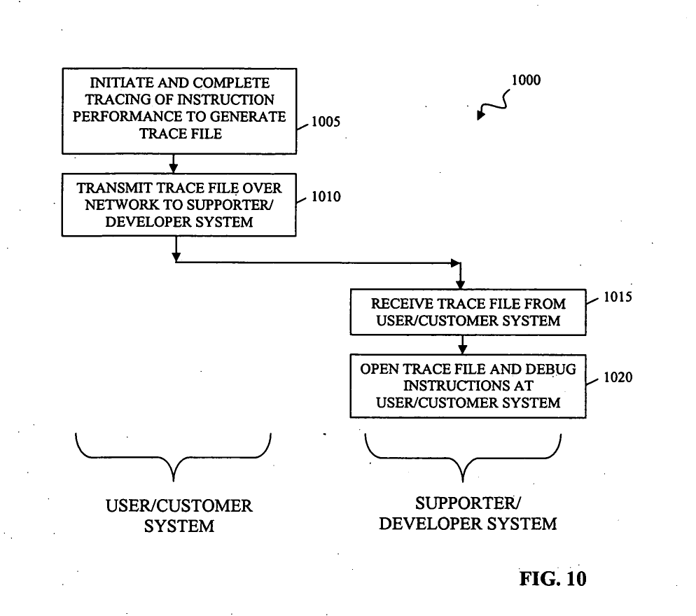

FIG. 10 is a flowchart of a process 1000 for tracing the performance of machine-readable instructions in a system landscape to debug the instructions. Process 1000 can be performed in part by user/customer system 905 and in part by supporter/developer system 910. User/customer system 905 can be adapted for tracing the performance of machine-readable instructions. For example, user/customer system 905 can be a system for tracing the performance of machine-readable instructions, such as systems 300, 400 (FIGS. 3, 4).

In particular, the tracing of a performance of machine-readable instructions in a user/customer system 905 can be initiated and completed at 1005, without involvement of supporter/developer system 910. The tracing can be initiated by a user or a customer. The tracing can be completed by a user or a customer. The tracing can generate a trace file. Please note that multiple performances of machine-readable instructions can be traced simultaneously, and the completion of the tracing of one performance need not deactivate the tracing of other performances.

The generated trace file can be transmitted by user/customer system 905 over a data network to supporter/developer system 910 at 1010. In some implementations, the trace file can be transmitted in conjunction with the first notice provided to supporter/developer system 910 that machine-readable instructions at user/customer system 905 are not performing as expected.

The generated trace file can be received from the user/customer system 905 by supporter/developer system 910 at 1015. As mentioned above, this can be the first notice provided to supporter/developer system 910 that machine-readable instructions at user/customer system 905 are not performing as expected.

The trace file can be opened and performance of the traced instructions at user/customer system 905 can be debugged at 1015. Note that a subsequent communication of tracing information may be unnecessary and debugging may be able to proceed exclusively based on the contents of the received trace file.

Various implementations of the systems and techniques described here can be realized in digital electronic circuitry, integrated circuitry, specially designed ASICs (application specific integrated circuits), computer hardware, firmware, software, and/or combinations thereof. These various implementations can include one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) may include machine instructions for a programmable processor, and can be implemented in a high-level procedural and/or object-oriented programming language, and/or in assembly/machine language. As used herein, the term “machine-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing environment that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the environment can be interconnected by any form or medium of digital data communication (e.g., a communication network). Examples of communication networks include a local area network (“LAN”), a wide area network (“WAN”), and the Internet.

A number of implementations have been described. Nevertheless, it will be understood that various modifications may be made. For example, process steps can be performed in different order, and steps can be omitted, and meaningful results nevertheless achieved. Accordingly, other implementations are within the scope of the following claims.

What is claimed is:

1. A system comprising:
a first tracing collector to collect interaction information regarding an interaction with a human user at a first data processing system in a system landscape during a performance of a set of machine-readable instructions;
a second tracing collector to collect internal information regarding a provision of services by a second data processing system in the system landscape to the first data processing system during the performance of the set of machine-readable instructions, the provision of services being associated with the interaction with the human user; and
a tracing application to receive the interaction information from the first tracing collector and the internal information from the second tracing collector and to assemble the interaction information and the internal information into a trace file regarding the performance.

2. The system of claim 1, wherein the first tracing collector comprises a portion of an application that interacts with the human user.

3. The system of claim 1, wherein the information regarding the interaction with the human user comprises a screen shot during the interaction.

4. The system of claim 1, wherein the second tracing collector comprises a supplemental application that collects data regarding a second application for the provision of the services.

5. The system of claim 1, wherein the internal information comprises at least one of a name of a subroutine and a value of a data variable.

6. The system of claim 1, wherein the trace file comprises:
step-invariant trace data that does not change during the performance; and
step-variant trace data that changes during the performance.

7. The system of claim 1, wherein:
the system further comprises a third tracing collector to collect a user comment regarding the performance of the set of instructions; and
the tracing application receives the user comment from the third tracing collector and assembles the user comment into the trace file.

8. The system of claim 1, wherein the tracing application is to assemble the interaction information and the internal information into a data structure that includes step-delimited collections of time-variant information.

9. The system of claim 1, wherein the data structure comprises a trace session file that is delimited as to a particular set or subset of machine-readable instructions whose performance is traced.

10. An article comprising one or more machine-readable media storing instructions operable to cause one or more machines to perform operations comprising:
receiving client tracing information that is relevant to a performance of a set of machine-readable instructions at a client data processing system in a data processing system landscape;
receiving server tracing information that is relevant to the same performance of the same set of machine-readable instructions at a server data processing system in the data processing system landscape; and
assembling the client tracing information and the server tracing information to generate a trace file regarding the performance of the set of machine-readable instructions.

11. The article of claim 10, wherein the operations further comprise:
receiving a user comment on the performance of the set of machine-readable instructions; and
assembling the user comment into the trace file.

12. The article of claim 10, wherein the operations further comprise:
receiving an identity of a human user; and
responding to requests from one or more applications to indicate that operations performed for the human user are to be traced.

13. The article of claim 12, wherein the operations further comprise:
notifying the human user about the tracing of operations to be performed for the human user.

14. The article of claim 10, wherein:
the server tracing information comprises internal information regarding a provision of services by the server data processing system to the client data processing system; and
the client tracing information comprises interaction information regarding an interaction with a human user at the client data processing system.

15. The article of claim 10, wherein server tracing information comprises:
receiving step-invariant trace data that does not change during the performance of the set of machine-readable instructions; and
receiving step-variant trace data that changes during the performance of the set of machine-readable instructions.

16. The article of claim 10, wherein assembling the client tracing information and the server tracing information to generate the trace file comprises adding the client tracing information and the server tracing information to a subdivision of a structured trace file, wherein the subdivision is associated with a step in the performance of the set of machine-readable instructions.

17. The article of claim 10, wherein assembling the client tracing information and the server tracing information comprises comparing the client tracing information with the server tracing information to identify instructions to which the client tracing information and the server tracing information are relevant.

18. A machine-implemented method comprising:
collecting interaction information regarding an interaction with a human user at a client data processing system in a system landscape;
transmitting the collected interaction information to a tracing service;
collecting internal information regarding a provision of services by a server data processing system in the system landscape, the provision of services being associated with the interaction with the human user at the client data processing system;
transmitting the collected internal information to the tracing service; and
at the tracing service, conveying the collected interaction information and the collected internal information to at least one of a supporter and a developer in conjunction with a first notification that a performance of machine-readable instructions at system landscape is not meeting expectations.

19. The method of claim 18, further comprising:
collecting a user comment regarding the performance of the set of instructions at a client data processing system in a system landscape;
transmitting the user comment to the tracing service; and
at the tracing service, conveying the user comment with the first notification.

20. The method of claim 18, further comprising outputting at least some of the collected interaction information and the collected internal information to at least one of the supporter and the developer.
